(19) United States
(12) Patent Application Publication
(10) Pub. No.: US 2011/0320784 A1
(43) Pub. Date: Dec. 29, 2011

(54) VERIFICATION OF PROCESSOR ARCHITECTURES ALLOWING FOR SELF MODIFYING CODE

(75) Inventors: Eli Almog, Poughkeepsie, NY (US); Christopher A. Krygowski, Lagrangeville, NY (US); Yugi Morimoto, Poughkeepsie, NY (US); Michal Rimon, Nofit (IL)

(73) Assignee: INTERNATIONAL BUSINESS MACHINES CORPORATION, Armonk, NY (US)

(21) Appl. No.: 12/822,553

(22) Filed: Jun. 24, 2010

(51) Int. Cl. G06F 9/30

(52) U.S. Cl. 712/227; 712/E09.032

(57) ABSTRACT

A verification operation including generating a predefined instruction, initializing a relevant self modifying code (SMC) target memory location to form an SMC trap, binding the SMC trap to the predefined instruction to form an SMC trap source and propagating initialization of instruction code into the SMC trap source.

### BACKGROUND

This invention relates generally to processing within a computing environment and, more particularly, to verification of architectures allowing for self modifying code utilizing a follow the execution path test generator.

In the context of hardware and software systems of, for example, computing environments, formal verification is the act of proving or disproving the correctness of intended algorithms underlying a system with respect to a certain formal specification or property. Formal verification can be helpful in proving the correctness of systems, such as cryptographic protocols, combinational circuits, digital circuits with internal memory and software expressed as source code. Verification is one aspect of testing a product's fitness for a particular purpose. Validation is the complementary aspect. Often, one refers to the overall checking process as V & V where validation attempts to answer the question of whether a product specified to a user's actual needs and verification attempts to answer the question of whether the product actually conforms to the specifications.

### BRIEF SUMMARY

In accordance with an aspect of the invention, a computer program product for a functional verification operation is provided and includes a tangible storage medium readable by a processing circuit and memory modifying instructions for execution by the processing circuit for performing a method including generating a predefined instruction, initializing a relevant self modifying code (SMC) target memory location to form an SMC trap, binding the SMC trap to the predefined instruction to form an SMC trap source and propagating initialization of instruction code into the SMC trap source.

In accordance with another aspect of the invention, an apparatus for performing verification is provided and includes a microprocessor in communication with a memory unit configured to perform a method including generating a predefined instruction, initializing a relevant self modifying code (SMC) target memory location to form an SMC trap, binding the SMC trap to the predefined instruction to form an SMC trap source and propagating initialization of instruction code into the SMC trap source.

In accordance with yet another aspect of the invention, a computer implemented method of verification is provided and includes generating a first predefined instruction and a second predefined instruction obeying result request, the generating of the first predefined instruction comprising initializing an operand of the first predefined instruction, making a target address a next instruction location, initializing the target address, binding a source operand, which is kept open, to data later to be placed in the target address to create a trap, initializing memory with instruction text and executing the first predefined instruction, and the generating of the second predefined instruction comprising initializing an operand of the second predefined instruction, triggering the trap and initializing an executing the second predefined instruction.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE SEVERAL VIEWS OF THE DRAWINGS

Referring now to the drawings wherein like elements are numbered alike in the several FIGURES in which:

FIG. 1 is a schematic illustration of an exemplary computing device;

FIG. 2 is a sample instruction of a test case generator tool;

FIG. 3 is a flow diagram illustrating an operation of the test case generator of FIG. 2;

FIG. 4 is a flow diagram illustrating an operation of the test case generator of FIG. 2 according to further embodiments; and

FIG. 5 is a flow diagram illustrating an exemplary embodiment in accordance with the present invention.

### DETAILED DESCRIPTION

In accordance with aspects of the present invention, the creation of functional verification test cases, which are used to verify architecturally correct behavior of processor designs, is provided. These test cases are, typically, generated by an automated generation tool that models the architectural behavior supported by the device under test. These test cases include assembly level language programs with initialization and expected final values of architected facilities (registers, memory, program status word, etc).

Test case generation tools may operate in a “follow the execution path” method which allows for robust user biasing and state space coverage. “Following the execution path” is defined as a process where a generator satisfies the user supplied biases on an instruction by instruction creation process. If the user specifies a branch or jump type instruction, the target of the branch and the fall through path does not necessarily need to be specified, nor does the behavior of the branch. The generator tool just assumes that the next instruction produced satisfies the next instruction bias.

Aspects of the present invention address the creation of such test cases exhibiting behavior referred to as Self Modifying Code (SMC), which is defined when a software program is allowed to create, modify or mutate its own instructions without advanced warning or special interlocks and the behavior of such must be handled correctly. Here, the term “correctly” refers to, e.g., fetching and executing operations in sequential order as dictated by the instruction flow and ordering of the program.

Several architectures support SMC. These include, but are not limited to, Z-Series and x86 processors, which are able to verify the correct architectural SMC behavior of a device under test. Robustly verifying the correct architectural SMC behavior of the device under test requires a level of biasing of the regularly generated instruction also given to SMC initialization and the stored, eventually executed code. Since the latter is being generated as a data store access of one or several instructions, it typically has only a basic level of data biasing.

Creating SMC test cases with a “following the execution path” test generator may be challenging, however, since these tools are designed to avoid previously modified storage and typically employ an escape process that allows them to share instruction and operand memory space without creating ordering conflicts. However, this is often the SMC behavior that is being tested thus creating a conflict. The user can override the conflict created by the escape process but the biasing of the original and final storage value may be limited. Meanwhile, extending support by making the stored data more intricate may lack a required level of control and randomness due to the fact that the stored, executed instruction code can be a combination of several stores and the initialization. Creating partial instruction code extends the level of the required data access biasing and exponentially multiplies an amount of possibly interesting combinations. Also, a gap between the SMC storing instruction and the SMC location may vary.

In accordance with aspects of the present invention, a solution is proposed to answer the verification requirements allowing a same level of bias control to the modified instruction stream as to the regularly generated one. The solution includes use of a trapping mechanism to provide a robust bias to an executed (i.e., modified) instruction path. This trap allows for the late binding of data. The victim of the SMC (i.e., the original instruction) is lightly biased with some predefined values with some randomization or biased data. Advantages of this solution allow for creation of a trap detached from the generation of the stored, executed instruction, the stored, executed instruction gets a same level of biasing as a regularly generated one and, in fact, from a verification scenario writer perspective, control over the stored, executed instruction may be identical or substantially similar to control over the regularly generated instruction, a single instruction can be randomly generated over several traps, several instructions can be generated over a single trap, SMC traps can be created with random distances between before or after the storing instruction and the SMC trap does not have to be used, creating false SMC conditions.

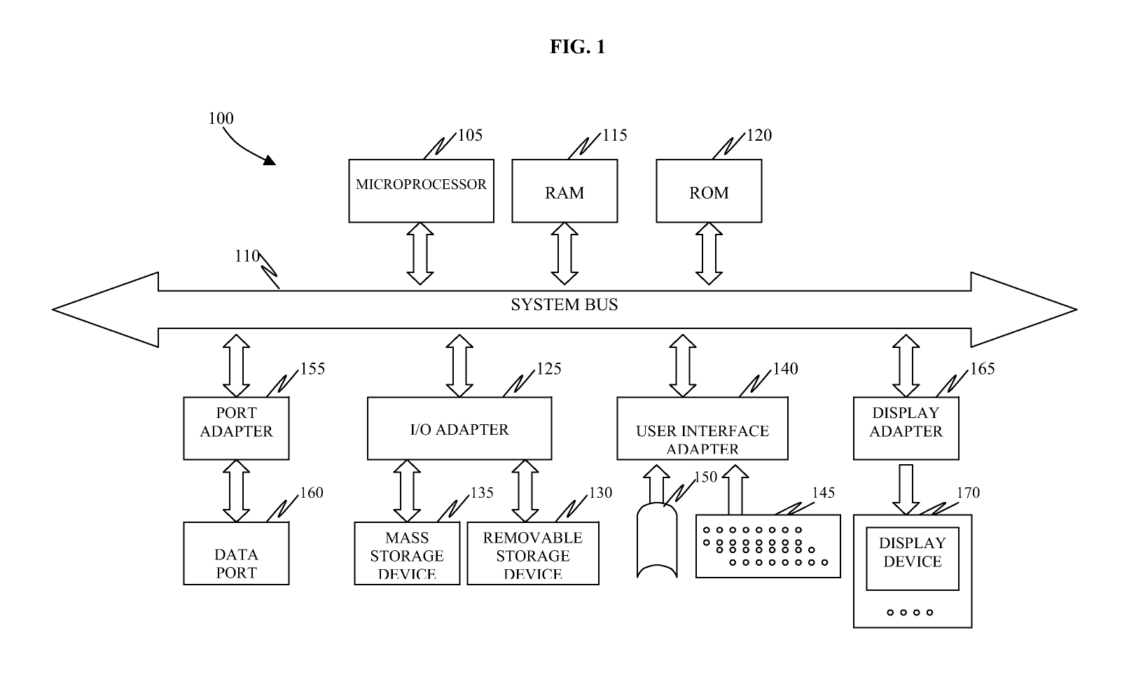

With reference to FIG. 1, an exemplary computing device 100 is provided by which the methods of the present invention may be conducted. The computing device 100 includes a central processing unit (CPU), such as a microprocessor 105, and memory or storage units, such as random access memory (RAM) 115 and read-only memory (ROM) 120). The CPU and the memory or storage units are coupled to and disposed in signal communication with one another via a system bus 110. Also coupled to and disposed in signal communication with the system bus 110 may be an I/O adapter 125, a user interface adapter 140, a port adapter 155 and a display adapter 165. The I/O adapter 125 may be coupled to a removable storage device 130 and a mass storage device 135. The user interface adapter 140 may receive input from a keyboard 145 and/or a mouse 150. The port adapter 155 may be coupled to a data port 160 and the display adapter 165 may be coupled to a display device 170.

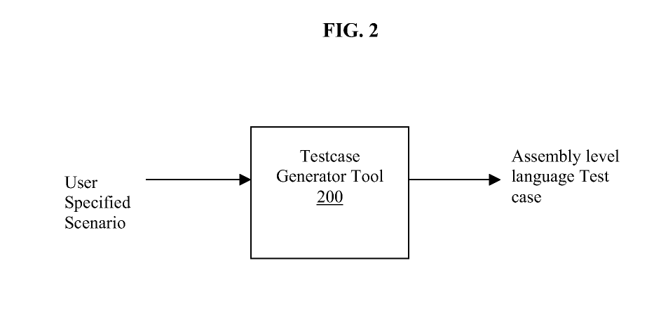

The memory or stage units may include a non-transitory computer readable medium having executable instructions stored thereon. When executed, these executable instructions may be configured to cause the CPU to operate in the manner described below with reference to FIGS. 2-5.

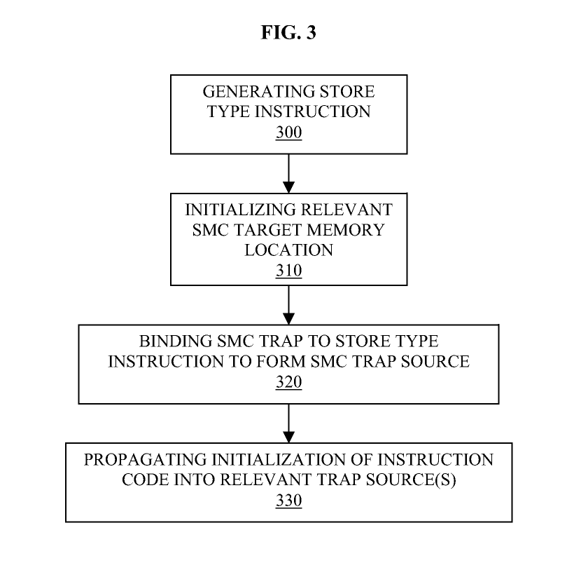

As shown in FIG. 2, the SMC generation takes place within a test case generator tool environment in which input to a test case generator 200 which may be embodied by the microprocessor 105 of FIG. 1, is a user requested or specified scenario and output is an assembly level language test case. Here, for purposes of further explanation it is assumed that the user requested scenario is a store instruction and an add instruction with a requirement for a sum of operands to be zero. As shown in FIG. 3, the SMC generation includes generating a store type instruction (300), with an uninitialized or reloaded source, initializing a relevant SMC target memory location to form an SMC trap with random data or with data that is biased towards interesting corner cases (310), binding the SMC trap to the memory modifying instruction to form an SMC trap source (320) and, upon generation of an instruction in the memory addresses located entirely or partially on the SMC trap or traps, propagating initialization of the instruction code into the relevant SMC trap source or sources (330).

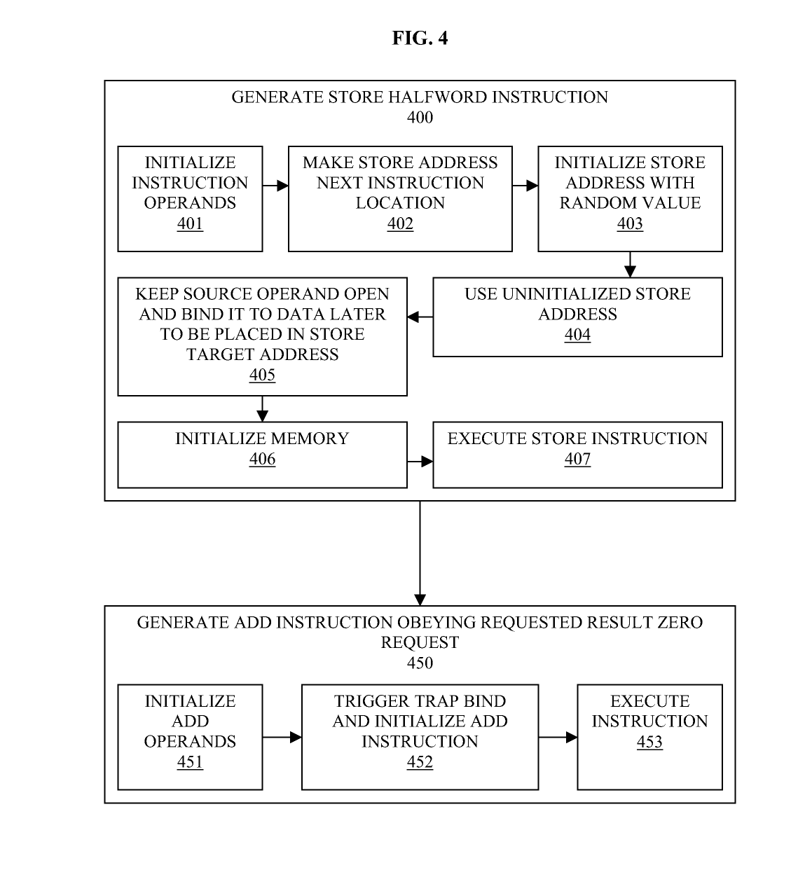

In greater detail, with reference to FIG. 4, the test case generator 200 (see FIG. 2) may take advantage of a user request for, e.g., a store instruction, to create an add instruction using SMC. That is, the test case generator tool 200 may generate, e.g., a first predefined instruction, such as a Store HalfWord instruction with a data operand that is 16 bits long (400), and second predefined instruction, such as an Add instruction obeying the requested result zero request (450). In order to accomplish the generating of operation 400, the test case generator 200 initializes all instructions operands (401), makes the store target address to be the next instruction location (402), initializes the store target address with a random value (i.e., SMC initialization) (403), uses an unintialized source operand (404), keeps the source operand data “open” and binds it to the data later to be placed in the store target address (405). Thus, the trap is created. At this point, memory is initialized with instruction text (406) and the store instruction is executed (407). In order to accomplish the generating of the Add instruction of operation 450, the test case generator 200 initializes the Add operands (451), triggers the trap bind and initializes the ADD instruction text in the store source (452) and executes the instruction (453).

As an example, in a tool embodiment, a StoreWord is generated from an uninitialized general purpose register to a predefined memory location, the predefined memory location is initialized, a word is bound in the predefined memory location to a value of the general purpose register and, when an certain instruction is generated in an address of the predefined memory location, a relevant part of the general purpose register is initialized with the certain instruction.

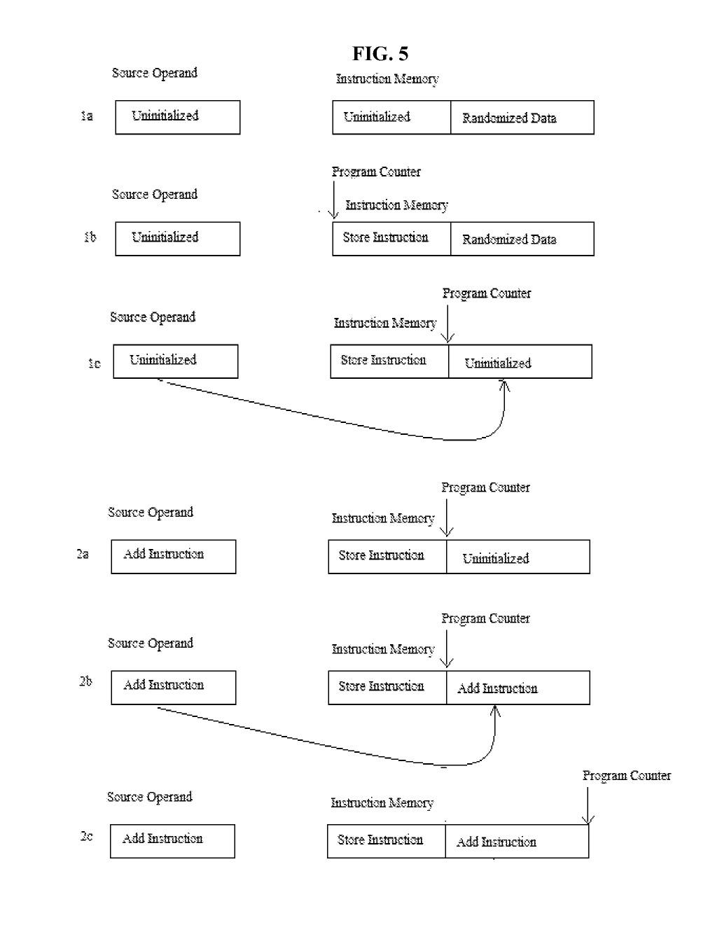

That is, with reference to FIG. 5, which is a flow diagram illustrating an exemplary embodiment in accordance with the present invention, it is seen that, initially, memory and register values are set at the current program counter of 0X2000 and that after operation 1a of generating instruction “STH 6,004(8,7)” in which the source operand is uninitialized and the instruction memory includes an uninitialized section and a section stored with randomized data such that G7: 0X0000_{—}0000_{—}0000_{—}2000, G8: 0X000_{—}0000_{—}0000_{—}0000 where the store address is 2004, and G6: 0X1234_{—}5678_{—}9ABC_XXXX. The low part of G6, which is to be stored, is kept uninitialized and will be bound to the SMC location. Also, 2004: 0X1294_{—}0033_{—}0055 such that random data is initialized as the SMC unit. After operation 1b in which the source operand is uninitialized, the program counter is set at the starting address of the section of the instruction memory that was previously uninitialized and is currently initialized with a store instruction and the section of the instruction memory previously stored with randomized data remains stored with randomized data such that 2000:0X506780004 and instruction STH 6,004 (8,7). Then, after operation 1c, the program counter has been set at the starting address of the section of the instruction memory previously stored with randomized data but now includes the uninitialized source operand such that a trap (i.e., a 2 byte trap) is created at address 2004 with its data bound to the G6 initial value.

After operation 2a whereby instruction “AR E,5” is generated, the source operand includes an Add instruction such that G5: 0XFFFF_FFFF_FFFF_FFFF and GE: 0X0000_{—}0000_{—}0000_{—}0001. After operation 2b, which is the triggering trap operation in which the “AR E,5” instruction text is 1AE5, the Add instruction is applied to the section of the instruction memory previously uninitialized such that G6: 0X1234_{—}5678_{—}9ABC_{—}1AE5. That is, a late bind is triggered to fix the G6 initial data. Finally, after operation 2c, the program counter is set at the ending address of the instruction memory and GE: 0X000_{—}0000_{—}0000_{—}0000.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all features in the claims below are intended to include any structure, material or act for performing the operation in combination with other claimed features as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were described in order to best explain the principles of the invention and the practical application, and to enable others of ordinary skill in the art to understand the invention for various embodiments with various modifications as are suited to the particular use contemplated.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more non-transitory computer readable medium(s) having computer readable program code embodied thereon.

Any combination of one or more non-transitory computer readable medium(s) may be utilized. The non-transitory computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible or non-transitory medium that can contain, or store a program for use by or in connection with an instruction execution system, apparatus, or device.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, cause execution of the operations/acts specified in the flowchart and/or block diagram block or blocks.

These computer program instructions may also be stored in a non-transitory computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams illustrate architecture, functionality and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

1. A computer program product for a functional verification operation, comprising a tangible storage medium readable by a processing circuit and memory modifying instructions for execution by the processing circuit for performing a method comprising:
generating a predefined instruction;
initializing a relevant self modifying code (SMC) target memory location to form an SMC trap;
binding the SMC trap to the predefined instruction to form an SMC trap source; and
propagating initialization of instruction code into the SMC trap source.

2. The computer program product according to claim 1, wherein the predefined instruction comprises a memory modifying instruction.

3. The computer program product according to claim 1, wherein the predefined instruction comprises a memory modifying instruction with an uninitialized source.

4. The computer program product according to claim 1, wherein the predefined instruction comprises a memory modifying instruction with a reloaded source.

5. The computer program product according to claim 1, wherein the SMC trap is formed with random data.

6. The computer program product according to claim 1, wherein the SMC trap is formed with biased data.

7. The computer program product according to claim 1, wherein the SMC trap is plural in number.

8. The computer program product according to claim 7, wherein the SMC trap source is plural in number.

9. The computer program product according to claim 1, wherein the propagating of the initialization of the instruction code occurs upon generation of an instruction in a memory address corresponding to the SMC trap.

10. An apparatus for performing verification, the apparatus comprising:
a microprocessor in communication with a memory unit configured to perform a method comprising:
generating a predefined instruction;
initializing a relevant self modifying code (SMC) target memory location to form an SMC trap;
binding the SMC trap to the predefined instruction to form an SMC trap source; and
propagating initialization of instruction code into the SMC trap source.

11. The apparatus according to claim 10, wherein the predefined instruction comprises a memory modifying instruction.

12. The apparatus according to claim 10, wherein the predefined instruction comprises a memory modifying instruction with an uninitialized source.

13. The apparatus according to claim 10, wherein the predefined instruction comprises a memory modifying instruction with a reloaded source.

14. The apparatus according to claim 10, wherein the SMC trap is formed with random data.

15. The apparatus according to claim 10, wherein the SMC trap is formed with biased data.

16. The apparatus according to claim 10, wherein the SMC trap is plural in number.

17. The apparatus according to claim 16, wherein the SMC trap source is plural in number.

18. The apparatus according to claim 10, wherein the propagating of the initialization of the instruction code occurs upon generation of an instruction in a memory address.

19. The apparatus according to claim 18, wherein the memory address corresponds to the SMC trap.

20. A computer implemented method of verification, the method comprising:
generating a first predefined instruction and a second predefined instruction obeying a result request,
the generating of the first predefined instruction comprising initializing an operand of the first predefined instruction, making a target address a next instruction location, initializing the target address, binding a source operand, which is kept open, to data later to be placed in the target address to create a trap, initializing memory with instruction text and executing the first predefined instruction, and
the generating of the second predefined instruction comprising initializing an operand of the second predefined instruction, triggering the trap and initializing an executing the second predefined instruction.
